(19) United States
(12) Patent Application Publication
(10) Pub. No.: US 2022/0172575 A1
(43) Pub. Date: Jun. 2, 2022

(54) SYSTEMS AND METHODS FOR WAGERING GAMES CONTINGENT ON LIVE SPORTING EVENTS

(71) Applicant: Deja Vu Sports LLC, Phoenix, AZ (US)

(72) Inventor: Thomas Sapienza, Phoenix, AZ (US)

(21) Appl. No.: 17/540,094

(22) Filed: Dec. 1, 2021

Related U.S. Application Data
(60) Provisional application No. 63/120,021, filed on Dec. 1, 2020.

(51) Int. Cl. G07F 17/32; G06Q 50/34

(52) U.S. Cl. CPC G07F 17/3288; G06Q 50/34; G07F 17/3272; G07F 17/323

(57) ABSTRACT

Methods and systems for managing a live wagering system are described. The method of live wagering uses a set of defined, event-dependent possible outcomes that are established after the placement of a wager and recur in order for the wager to win. Embodiments of the invention include a wagering system using a physical table game layout, an electronic gaming device, or a mobile application, and include a wide array of live events, especially sports games.

### CROSS-REFERENCE TO RELATED APPLICATION

The present application is related to U.S. Provisional Patent Application No. 63/120,021, filed on Dec. 1, 2021, which is hereby incorporated in its entirety.

### FIELD OF THE INVENTION

The present invention relates to a system of wagering games that are based on tracking occurrences and repeated occurrences of specific events within publicized sporting events, including baseball, football, basketball, hockey and other major and popular sporting events, the underlying software, the system and method for setting, tracking, and resolving such wagers, and features of the wagering game and methods thereof.

### BACKGROUND OF THE INVENTION

As wagering games and betting on sports betting has become legal and accepted in more jurisdictions, in the United States and elsewhere, and has become exponentially increasingly popular as a form of entertainment and social activity, there is now a pronounced present need on developing new ways to play and to wager based on the sporting events to capitalize on the commercial appeal of this growing market and growing consumer interest. Current conventional sport event spectating practices generally consist of two types: (1) passive gatherings, e.g., at home, sports bars, restaurants, wherein no wagering takes place, or (2) single-bet online or sportsbooks spectating, wherein a consumer places one or more wagers prior to the event that are contingent upon a single event (a victory over the point spread, a proposition bet based on number of first team to score, etc.), wherein the spectator actually remains passive during the sporting event itself and is generally not permitted to place additional wagers during the course of the sporting event itself.

The present invention offers an exciting new and novel break from this passive sports spectating experience in that, based upon events taking place during the game or sporting event itself, new possible real-time wagering events (with corresponding calculated odds) arise either during natural transition points in the sporting event (e.g., ends/beginnings of half-innings in baseball, change in serve in tennis) or arise during specific actions taking place during the sporting event (e.g., a strikeout, a single, a corner kick, or an ace), and these new wagers resolve themselves (and/or may be repeated, or may trigger other new wagering opportunities) in a small durational span within the sporting event itself (e.g., within the current half-inning in a baseball game) allowing the feel of greater spectator involvement in the sporting event and allowing an increase in the wagering action that takes place during the sporting event for the casino “house” or host venue (e.g., sportsbar, restaurant).

### SUMMARY OF THE INVENTION

In the present invention, a preferred embodiment provides for a table game that resembles a craps table, that is modified or may be modified to indicate possible bets that relate to the associated sporting events, i.e., a “sports craps” table, that for example, ground outs, hits, fly outs, strikeouts, walks, etc. In preferred embodiments of the invention, a (craps-style) “point” may be set by a particular action or event taking place within the larger sporting event itself, e.g., a hit in a baseball game. In such a system, the “point” would be made if the point action were repeated, e.g., a subsequent batter in the same half-inning also got a hit, prior to a “seven-out” event taking place in the actual sporting event. In preferred embodiments of the present invention, play-by-play information is tracked by the sports craps game system itself or fed to each sports craps game in real time and used to determine the actions of the game, including the movement of the button, as well as the determination of whether a wager is won, lost, pushed, set, or unaffected. In the case where the game is being played through a digital application, the information is used to automate the game and is fed to the game via a server. The server may receive this information in a number of ways, including via information generated by software programmed to directly interpret event outcomes and/or information fed directly to the server through a protected, exclusive interface where data is entered manually during event observation. In a particular embodiment of the invention, the method of manual data entry is being employed for the game. In a particular preferred embodiment of the sports craps game, played with a physical game table or board, the play-by-play information is interpreted directly by a non-participant of the game relying upon the game play-by-play feed (i.e., a “dealer”) and thereby game play may be monitored, bets resolved and payouts calculated and administered in real time.

### BRIEF DESCRIPTION OF THE DRAWINGS

In the accompanying drawings which form a part of the specification and are to be read in conjunction therewith, and in which like reference numerals are employed to indicate like parts in the various figures:

FIG. 1 is a frontal view of an electronic display representation of the present invention, according to an exemplary embodiment, wherein a baseball craps game wagering layout version for mobile electronic devices is depicted.

FIG. 2 is a frontal view of an electronic display representation of the present invention, according to an exemplary embodiment, wherein a football craps game wagering layout version for mobile electronic devices is depicted.

FIG. 3 is a frontal view of an electronic display representation of the present invention, according to an exemplary embodiment, wherein a basketball craps game wagering layout version for mobile electronic devices is depicted.

FIG. 4 is a frontal view of an electronic display representation of the present invention, according to an exemplary embodiment, wherein a hockey craps game wagering layout version for mobile electronic devices is depicted.

FIG. 5 is a frontal view of an electronic display representation of the present invention, according to an exemplary embodiment, wherein a soccer craps game wagering layout version for mobile electronic devices is depicted.

FIG. 6 is a frontal view of an electronic display representation of the present invention, according to an exemplary embodiment, wherein a tennis craps game wagering layout version for mobile electronic devices is depicted.

FIG. 7 is a perspective view of an electronic display representation of the present invention, according to an exemplary embodiment, wherein a baseball craps game wagering layout version for mobile electronic devices is depicted as provided to and used by an end-user.

FIG. 8 is a frontal view of an electronic display representation of the present invention, according to an exemplary embodiment, wherein a user betting/wagering offer and distribution screen for a baseball craps game wagering layout version for mobile electronic devices is depicted.

FIG. 9 is a frontal view of an electronic display representation of the present invention, according to an exemplary embodiment, wherein a manual officiant/moderator play-by-play recording and monitoring input screen for a baseball craps game wagering version is depicted.

FIG. 10 is a perspective view of an illustrative table game layout representation of the present invention, according to an exemplary embodiment, wherein a baseball craps game wagering version for indoor establishment use for one or more players is depicted.

These components in the figures are not necessarily to scale, emphasis instead being placed upon illustrating the principles of the invention. In the figures, identical reference numerals, letters, or other identifying symbols may designate corresponding parts or designate corresponding game play elements throughout the different views, dependent on contextual usage.

### DETAILED DESCRIPTION OF THE INVENTION

In the present invention, Sports Craps is a family of games where players will place wagers based on the recurrence of specific plays during defined intervals of live sports games. The defined intervals will vary from sport to sport, but may include set stoppages in play (e.g., an inning of baseball), varying stoppages in play (e.g., a time between faceoffs in hockey), intervals based on play outcomes (e.g., time between throw-ins in soccer), set time intervals (e.g., 30 second intervals), or any other intervals deriving from the specific gameplay of the relevant sport of interest.

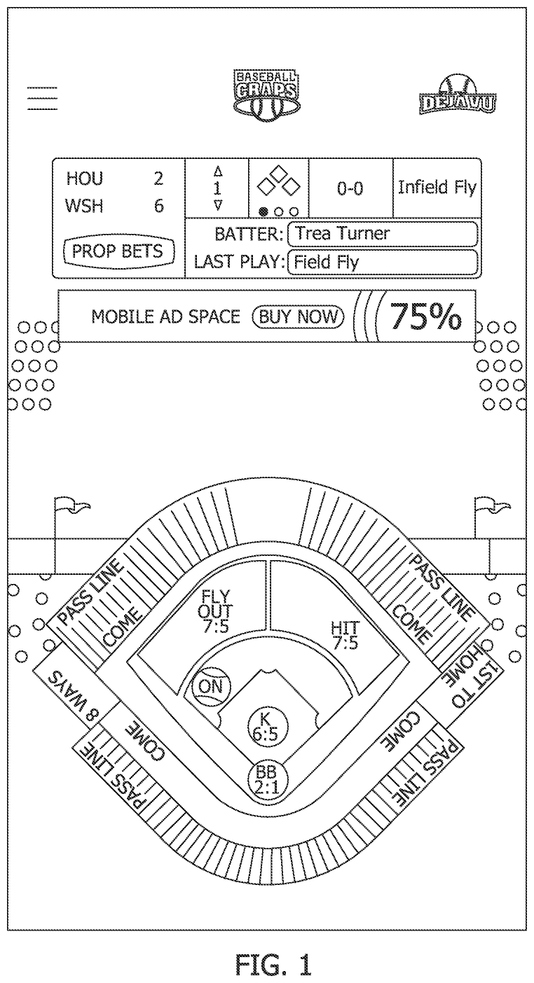

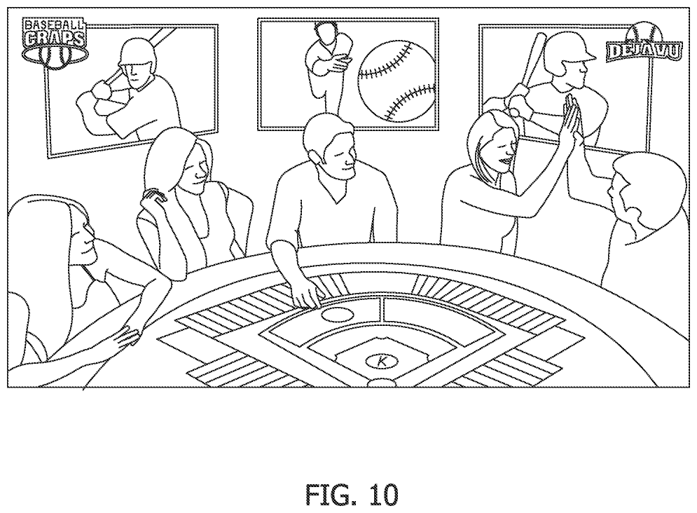

As depicted, e.g., in FIG. 1 and FIG. 10, in a preferred embodiment of the present invention, the games employ the use of a Pass Line, a Come Line, and a marker/button, corresponding to their use in the popular casino game Craps. Each defined interval begins with the button in the OFF position.

In a preferred embodiment making use of a pass line bet, while the button is in the OFF position, gameplay is initiated by placing chips on the pass line as an “ante.” In mobile application embodiments, a specific pass line spot may be illuminated upon selecting the chip. In particular embodiments, chips values may correspond to a player's point score or may represent exchanged money.

Further, according to a preferred embodiment, when one of a specific set of selected target plays occurs in the live sports game, the button is moved to the ON position at the location of that play. The play designated by the button in the ON position is referred to as the “point” in a manner akin to conventional table-game craps.

Further, according to a preferred embodiment, if the established “point” play occurs again before the end of the previously determined betting interval, the pass line bet has won and the player will be awarded an amount that substantially corresponds to the proper actual odds of the point being made. In a particular embodiment and particular play scenario, the payout may match a 1:1 correspondence with the pass line bet. In certain embodiments, the odds for specific play scenarios may be fixed prior to the game play session. In other preferred embodiments, the odds for specific play scenarios may adjust during the course of the sporting event; however, the odds for any given bet should not change once that bet is placed until that bet is resolved.

Upon a winning point, the bet is resolved, and the button reverts back to the OFF position.

In a preferred embodiment, if the defined interval concludes without the point recurring, such event corresponds to a “seven-out” in conventional table-game craps with the pass line bet resolved as a loss, and then the pass line chips are removed, and the button will revert back to the OFF position to start the next interval.

In a preferred embodiment, a player may play “odds,” in that while the button is in the ON position, a player may, in addition and in tandem with their pass line bet, play a defined additional amount of chips, usually a multiple of their initial play. This is done by placing chips directly behind the chips already placed on the pass line. In preferred mobile application embodiments, chips will be dragged to the pass line spot that is illuminated when the odds bet is available. The additional chips bets are termed “odds bets” and, upon winning, will be awarded additional points, based substantially on the odds/probability of target play recurring. In a particular preferred embodiment of the invention, these odds are available to the player at all times and may be listed on each target play's label on the game board or in a digital menu. Odds may be updated to most accurately reflect actual gameplay results and set an appropriate overall win/loss market, yet are not to be adjusted while betting action is in play.

In a preferred embodiment, game play features a wager corresponding to the COME LINE in table-game craps, such that while the button is in the ON position, a player may choose to place a new bet on the come line. Come line play is similar to the pass line play, yet can be done when the button is in the ON position. (Come line bets made while the button is in the OFF position may be reallocated to the pass line bet before a point is established.) After the come line bet is placed, the next target play that occurs will be set as the point for that bet. The chips are to be moved to the corresponding location of that play, and if the play recurs before the defined interval ends, the come line has won and the bet ends in resolution. If the defined interval ends without a repeat of the target play, the play “sevens out” and the come line bet is lost and the come line bets chips are removed from play.

As with the pass line, a player may add an additional amount of odds bet chips to their come line play. This is done by placing additional chips next to the previously placed chips AFTER they have been moved to the target play or, in mobile applications, dragging chips to the area illuminated next to the come bet chips after they have been moved. In a particular preferred embodiment, this odds bet may be in a value of a multiple of the pass line bet, e.g., 3× the pass line bet. Upon winning, the odds chips bets will be properly awarded based on the same schedule as the pass line.

In a preferred embodiment, the game play may feature inside bets, such that the game may have any number of pre-defined bets with corresponding areas on the game board. Termed “inside bets,” these areas will become available for play based on specific game situations. Chips can be placed directly on these areas when they are available for betting, and will be paid out based on the specific rules and/or applicable for such inside bet.

In a preferred embodiment, the game play may feature “pop up house bets.” Similar in nature to inside bets, such pop up bets become available for play based on specific game situations. The associated situations, however, are rare or transitory in nature, and thus do not feature as a regular and specific spot on the gameboard. Therefore, in some game layouts, a single spot may be used for all of these pop up bets, or in an app setting, a pop-up window may be used to notify the player of these bets. Regardless, the player will be given the set terms and odds of the bet that will not be changed once play action is live.

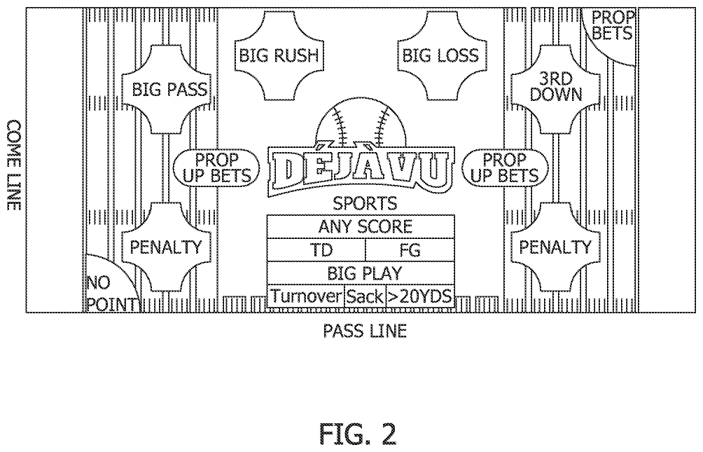

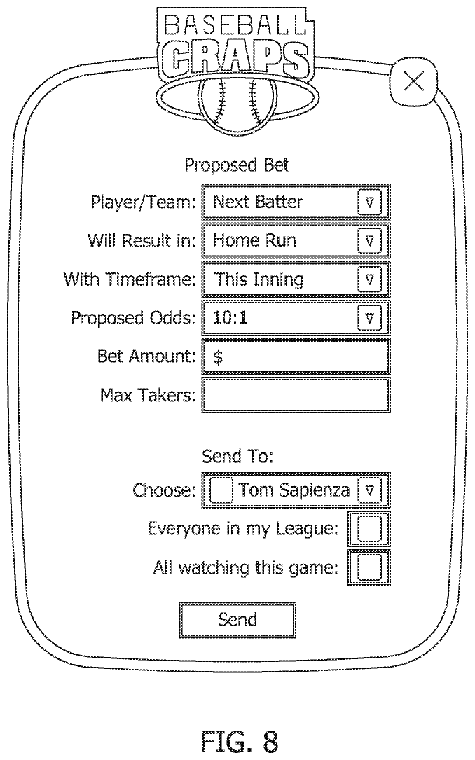

As depicted, e.g., in FIG. 2 and FIG. 8, in a preferred embodiment, the game play may feature “prop bets” or (player) “proposition bets,” which are player-to-player bets that have a multitude of possible permutations. Parameters such as play outcome, odds, timeframe, bet amount, etc., may be chosen by one player and proposed for acceptance by one or more other players. In a particular preferred embodiment, once a prop bet has been accepted and completed, based on the proposed timeline and/or outcome resolution, a separate game currency may be transferred to the winning player. In preferred embodiments, such prop bets may extend the game beyond the regular game board itself, because wager wins/losses are transferred directly from player to player.

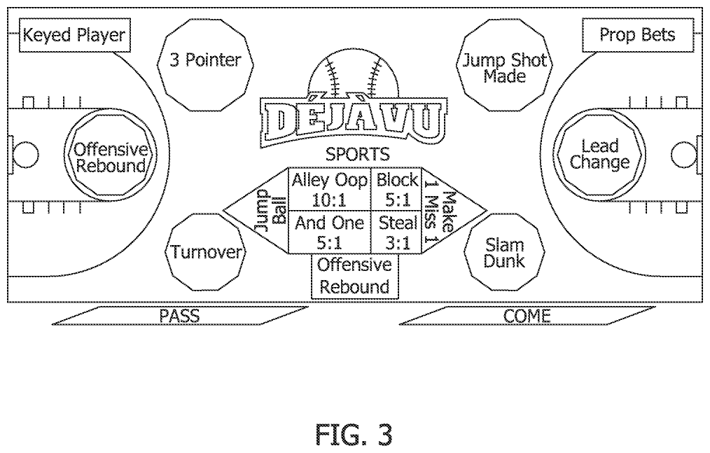

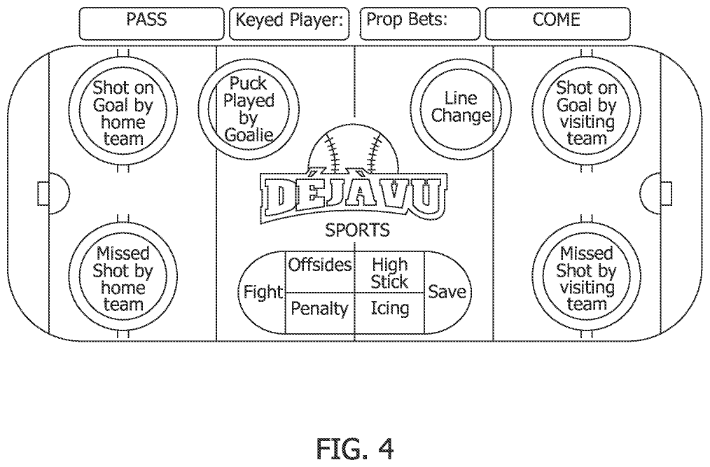

As depicted, e.g., in FIG. 3 and FIG. 4, in select preferred embodiments, the option to select for “keyed players” is made available to players, in that, in certain games, this feature allows a player to choose a single athlete from one of the starting lineups at the beginning of the game. If their “keyed player” is the player that causes them to win a bet, their win payout is adjusted accordingly

Comparison to Casino Craps

In preferred embodiments of the present invention, although each individual game in the family of Sports Craps is very similar to the simpler elements of Casino Craps, the most salient difference is that the dice are replaced with plays from separate but concurrent live sports games events. In a typical craps game, the button would start in the OFF position for a new roller and a point number would be established by their roll. The button would then be placed ON that number and the pass line bet would win if that number is rolled again before a “crap out seven.” In Sports Craps, the button starts in the OFF position at the beginning of every defined interval. Chips must be placed on the pass line as an “ante” bet before the defined interval begins. A result of live gameplay will determine which target play that the button is moved ON to and the pass line bet will win if that type of play recurs before the end of the defined interval. In summary, the target plays dictated by the live game simply replace the specific numbers rolled by the dice in conventional table game Casino Craps.

Similarly, come line bets work just like in conventional table game Casino Craps, in that they are the same as pass line bets, but occur after the button is already in the ON position. Pass line and come line odds work similarly as in Casino Craps; however, as the odds are different than the 1:1 pass/don't pass, come/don't come odds of table game craps, and are dependent upon the target play directly (whereas table game craps features independent dice rolls outcomes and thus the odds are stable and fixed), the payouts should correspond to the proper odds of the contemporaneous target play event.

Inside bets in Sports Craps are comparable to the inside bets on a Craps table, which may include the hard ways bets, the horn bets, any craps bets, the field bet, and others. In Sports Craps, just like Casino Craps, these bets are not directly related to the pass Line or come Line bets, and have their own rules, based on when they are available, how long they are active, their odds, and the outcomes that determine their win or loss. Different sports will feature different game specific inside bets.

The present invention features salient differences from conventional table game casino craps play, in part: (1) there are no placed bets in Sports Craps, meaning that a player cannot bet specific outcomes of upcoming plays. The reason for this is that the odds for each play change drastically depending on the specific live game situation, and (2) there is no automatic wins or losses when the button is OFF. Note, however, in particular embodiments, where the odds may be tracked and adjusted by the system in real-time to properly correspond and be properly calculated for the live sports event, place bets for specific game actions or outcomes may be set, and such a system may provide for bets and bet resolution while the point is being established (i.e., when the button is in OFF position).

Note that in the present invention, there is no Don't Pass Bar. Note again, in particular embodiments, where the odds may be tracked and adjusted by the system in real-time to properly correspond and be properly calculated for the live sports event, the system may be configured to determine and set up the opportunity and option lay proper odds against a certain game event occurring or recurring, and thus a don't pass bar-type bet may be implemented.

RULES. According to the present invention, the pass line and come line chips cannot be removed once their point has been established. These bets are now considered Active Bets. This matches play in conventional table game casino craps.

In a particular embodiment, featuring a point system, each player will start with 100 points.

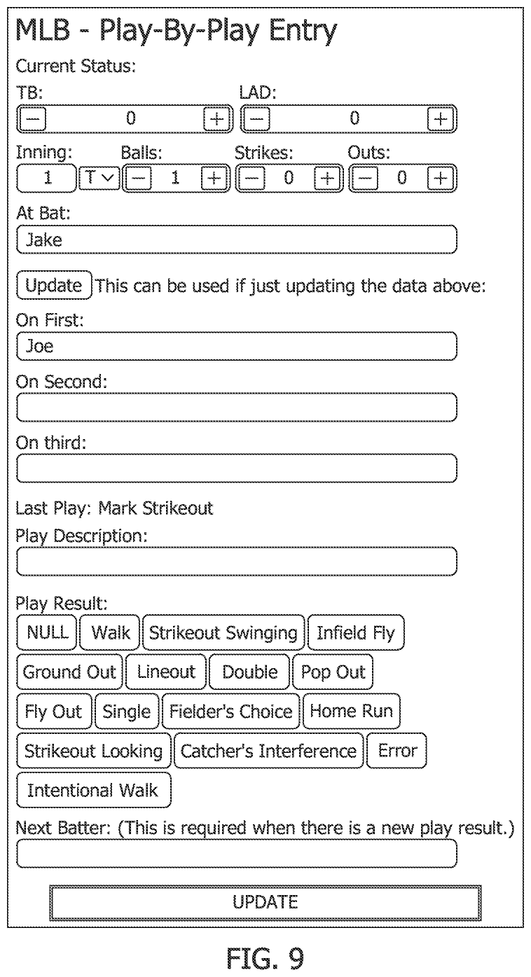

In preferred embodiments of the present invention, play-by-play information and odds information is tracked and evaluated by the sports craps game system software itself continuously in real time, or fed to each sports craps game in real time and used to determine the actions and payouts of the game, including the movement of the button, setting of the “point,” as well as the determination of whether a wager is won, lost, pushed, set, or unaffected. In the case where the game is being played through a digital application, the information is used to automate the game and is fed to the game via a server. The server may receive this information in a number of ways, including via information generated by software programmed to directly interpret event outcomes and/or information fed directly to the server through a protected, exclusive interface where data is entered manually during event observation. As depicted, e.g., in FIG. 9, in a particular embodiment of the invention, the method of manual data entry is being employed for the game. In a particular preferred embodiment of the sports craps game, played with a physical game table or board, the play-by-play information is interpreted directly by a non-participant of the game relying upon the game play-by-play feed (i.e., a “dealer”) and thereby game play may be monitored, bets resolved and payouts calculated and administered in real time.

In a preferred embodiment of the invention, the play and game bets may be incorporated and added into the layout and play of a conventional table game craps game, so that craps and sports craps may be hosted and played simultaneously in live table game settings, on electronic (casino) video game displays, or on mobile devices. In a particular preferred embodiment of the game, the game system software can monitor, track, record and evaluate play-by-play and odds information in real time, and the game system can further communicate and direct play, bet resolutions, and payouts to live craps table game staff concurrently and in parallel with an simultaneous and ongoing conventional craps table game.

In another preferred embodiment of the invention, the game system software can monitor, track, record and evaluate play-by-play and odds information to allow sports books and other betting host establishments to generate and process instantaneous new proposition bets (including single occurrence, recurring, or final event outcome bets) or other wagering opportunities during a live event, including sporting events, and the game system can further communicate the play-by-play and odds information and direct bet resolutions and payouts to the betting host establishment (e.g., casino “house” sportsbook), either for live in-person gaming (casino) venues, on electronic (casino) video game displays, or on mobile devices. In a particular preferred embodiment of the invention, the game system software can monitor, track, record and evaluate play-by-play and odds information in substantially real time automatically without user or operator input. In a particular preferred embodiment of the invention, the play-by-play information is input to the game system software as data conveyed substantially simultaneously in connection with the live sporting event broadcast transmission. In a particular preferred embodiment of the invention, the play-by-play information is presented in connection with the live sporting event broadcast transmission as machine-readable optical code. In another particular preferred embodiment of the invention, the play-by-play information is presented in connection with the live sporting event broadcast transmission as audio data, including preferably ultrasonic audio data.

SCORING. In a preferred embodiment, featuring a point system, each player's score will be tracked and the top scores will be presented on a leaderboard table. Players will have the ability to create preferred friends and groups with other players and will have the ability to create exclusive contests with those friends and/or within such groups. The game system software may provide an individualized scoreboard for these contests.

In another preferred embodiment, players will be offered contests by the game operator and may be awarded prizes based on performance in the contests. These contests may be of varying durations, ranging from within a single game to season-long contests. The contests may require a buy-in to participate, or may have a free-entry format.

In another preferred embodiment, a player's score and chip value may correspond with real money value. This embodiment may involve contest-style or player vs. house gaming style.

Baseball Craps—Overview and Rules

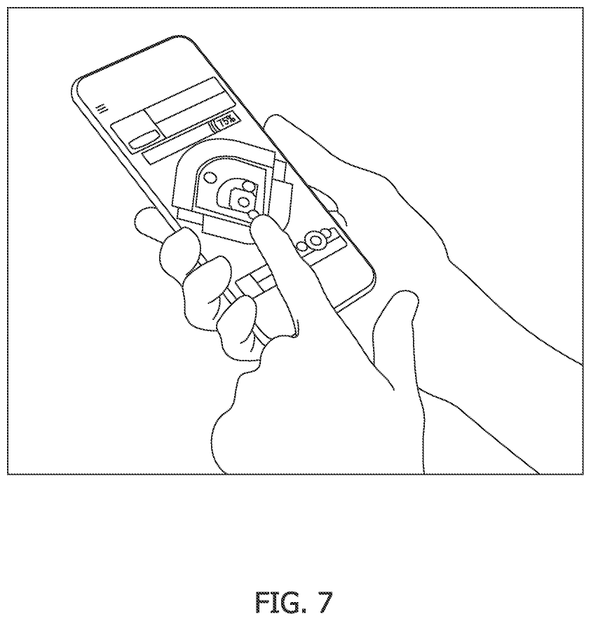

As depicted, e.g., in FIG. 1, FIG. 7 and FIG. 10, in a preferred embodiment of the present invention, Baseball Craps is a game where each player will accrue payouts or points based on the recurrence of specific plays during a half inning of a live baseball game.

Each half-inning will begin with the baseball shaped button in the OFF position

PASS LINE: While the button is in the OFF position, gameplay is initiated by placing chips on the Pass Line. In mobile applications, the Pass Line is illuminated upon selecting the chip. Chips values ($) correspond to a player's point score on a 1:1 basis.

When one of the specific Target Plays occurs in the baseball game (Strikeout (K), Walk (BB), Fly Out, Hit, Ground Out, Infield Fly Out), the button is moved to the ON position at the location of that play. The play designated by the button in the ON position is referred to as the Point.

If the Point play occurs again before the end of the 3-out half-inning, the Pass Line bet has won and the player will be awarded an number of chips that substantially corresponds to the proper odds payout determine by the Target Play. In certain target play conditions, the payout may be 1:1 the original bet.

Upon a winning Point, the button will revert back to the OFF position.

If the 3-out inning concludes without the Point recurring, the Pass Line chips are removed, the corresponding points are lost, and the button will revert back to the OFF position to start the next inning.

ODDS: While the button is in the ON position, a player may add to their Pass Line play an additional amount of chips up to 3× their initial play. This is done by placing chips directly behind the chips already placed on the Pass Line. In a mobile application, chips will be dragged to the Pass Line spot that is illuminated when the odds bet is available. The additional chips are called Odds and upon winning, will be awarded additional points based on the likelihood of the Target Play recurring. These odds are listed in the game menu and/or on each Target Play's label on the game board. In preferred embodiments, odds may be updated to most accurately reflect actual live gameplay conditions. In a particular fixed embodiment, points/odds are awarded based on the following schedule:

Strikeout (K): Player is awarded 6 points for each 5 points played as Odds; Hit: Player is awarded 6 points for each 5 points played as Odds;

Ground Out: Player is awarded 7 points for each 5 points played as Odds; A sacrifice bunt will result in a push with the odds bet returned to the player;

Fly Out: Player is awarded 7 points for each 5 points played as Odds; A sacrifice fly out will result in a push with the odds bet returned to the player;

Walk (BB): Player is awarded 2 points for each 1 point played as Odds. An intentional walk will result in a push with the odds bet returned to the player; and

Infield Fly: Player is awarded 3 points for each 1 point played as Odds.

COME LINE: While the button is in the ON position, a player may choose to place chips on the Come Line. Come Line play is similar to the Pass Line play but can be done when the button is in the ON position. After the Come Line chips are placed, the next Target Play that occurs will be the Point for those chips. The chips will move to the corresponding location of that play and if the play recurs before the 3-out inning ends, the Come Line has won.

As with the Pass Line, a player may add an additional amount of Odds chips up to 3× their initial Come Line play. This is done by placing additional chips next to the previously placed chips AFTER they have been moved to the Target Play or, in mobile applications, dragging chips to the area illuminated next to the Come bet chips after they have been moved. Upon winning, the Odds chips may be awarded points based on the same schedule as the Pass Line (see above).

INSIDE BETS: 8 WAYS BET: the 8 Ways bet is active when a player starts their at-bat, and the player has a null count (0-0). The bet is that the player will reach base, as there are 8 Ways possible to do so (Hit, Walk, Hit By Pitch, Fielder's Choice, Reach on an Error, Strikeout with Pass Ball, Catcher's Interference, Fielder's Interference). The bet is specific to the player at bat when the bet is placed. If a player is intentionally walked, the bet is NULL and the chips will be returned. In a preferred embodiment, the system will be set to track and determine the actual proper odds in real-time during the live game event and issue payouts that substantially correspond to the successful “8 Ways” outcome. In a particular embodiment, a winning bet will be awarded 1 point for every 1 that is bet.

FIRST TO HOME: The First To Home bet is active when a player is on first base. The bet is that the player will reach home, rather than be left stranded on base or called out. The bet is specific to the player on first base when the bet is placed. If a new player reaches first and the original player is still on base, another bet can be placed. In a preferred embodiment, the system will be set to track and determine the actual proper odds in real-time during the live game event and issue payouts that substantially correspond to the successful “First to Home” outcome. In a particular embodiment, a winning bet may be awarded 1 point for every 1 point bet.

POP-UP BETS: From time to time, situation specific bets will be presented with their respective odds. These one-play bets, called Pop Up bets, will present themselves by the activation of the POP UP BETS spot, where players will be given the option to place or deny the wager.

As depicted in FIG. 8, PROP BETS: Prop Bets are player-to-player bets that have a multitude of possible permutations. Parameters such as teams/players involved, play outcome, odds, timeframe, bet amount, etc. are chosen by one player and proposed for acceptance by one or more other players. Once a prop bet has been accepted and completed based on the proposed timeline, odds and/or outcome, a separate game currency may be transferred to the winning player. Prop bets extend the game beyond the Game Board because wager wins/losses are transferred directly from player to player.

Baseball Craps—Comparison to Table Game Casino Craps

In the present invention, although Baseball Craps is very similar to the simpler aspects of Casino Craps, the most salient difference is that the dice are replaced with plays of a live baseball game. In a typical Craps game, the button would start in the OFF position for a new roller and a point number would be established by their roll. The button would then be placed ON that number and the Pass Line bet would win if that number is rolled again before a “crap out seven”. In Baseball Craps, the button starts in the OFF position at the beginning of every half-inning (which is every time the teams switch fielding vs. batting). Chips must be placed on the pass line before that player has initiated their at-bat. The result of that at-bat will determine which of the 6 Target Plays that the button is moved ON to (Strikeout, Walk, Fly Out, Hit, Infield Fly, Ground Out) and the pass line bet will win if that type of play occurs before the end of the inning.

Come Line bets work just like in Casino Craps, as in they are the same as Pass Line bets, but occur after the button is already in the ON position.

Pass Line and Come Line Odds Work the Same as in Casino Craps

The First To Home and 8 Ways bets as similar to inside bets on the Craps table, such as the hard ways or The Field.

The First To Home bet is active when a player is on first base. The bet is that the player will reach home rather than be left stranded on base. The bet is specific to the player on first base when the bet is placed. If a new player reaches first and the original player is still on base, another bet can be placed. In particular embodiments, a winning bet may be awarded 1 point for every 1 point bet.

The 8 Ways bet is active when a player starts their at-bat and the player has a null count (0-0). The bet is that the player will reach base, as there are 8 Ways possible to do so (Hit, Walk, Hit By Pitch, Fielder's Choice, Reach on an Error, Strikeout with Pass Ball, Catcher's Interference, Fielder's Interference). The bet is specific to the player at bat when the bet is placed. If a player is intentionally walked, the bet is NULL and the chips will be returned. In a particular embodiment, a winning bet will be awarded 1 points for every point that is bet.

The Baseball Craps embodiments of present invention feature salient differences from conventional table game casino craps play, in part: (1) there are no placed bets in Baseball Craps, meaning that a player cannot bet specific outcomes of upcoming at-bats. The reason for this is that the odds for each play of each at-bat could change drastically depending on the specific batter and game situation, e.g., a game like this should not allow a player to bet “Walk,” when, in fact, an obvious intentional walk situation was upcoming; and (2) there are no automatic wins or losses when the button is OFF. Note, however, in particular embodiments, where the odds may be tracked and adjusted by the system in real-time to properly correspond and be properly calculated for the live sports event, place bets for specific at-bat or game actions or outcomes may be set and offered, and such a system may provide for bets and bet resolution while the point is being established (i.e., when the button is in OFF position).

Note that in the present invention, there is no Don't Pass Bar. Note again, in particular embodiments, where the odds may be tracked and adjusted by the system in real-time to properly correspond and be properly calculated for the live sports event, the system may be configured to determine and set up the opportunity and option lay proper odds against a certain at-bat event occurring or recurring, and thus a don't pass bar-type bet may be implemented.

In a particular embodiment of the Baseball Craps game, specific additional rules are as follows: 1. Each player will start with 100 points. 2. Chips cannot be placed on specific plays. 3. Pass Line and Come Line chips cannot be removed once their Point has been established. These bets are now considered Active Bets. 4. Half points and partial points do not exist, and fractional points will always be rounded down. Therefore, whereas a 5 point bet on a point that yields 6:5 will pay 6 points, a 4 point bet on that same spot will only yield 4 points.

In a particular embodiment of the Baseball Craps game, a specific 2-OUT RULE applies, such that, if an active Pass Line bet is on a Point play that represents an out (Strikeout, Ground Out, Infield Fly, Fly Out) AND a Come Line bet is placed that results in another out play, a situation will exist where the Pass Line and Come line bets can't both win. Therefore, the player may be given a choice as to which play is to remain active for that half inning. The other bet is then removed and those points returned to the player. Regardless of the Pass Line vs Come Line decision, the player may place a new Come Line bet for the next play.

Play Specific Rules:

In certain Baseball Craps embodiments, and due to overlap and confusion of the multitude of possible baseball plays, select common plays may be treated by the game as follows:

Hit By Pitch=Walk

Catcher's Interference=Walk

Single, Double, Triple, HR=Hit

Fielder's Choice=Ground Out

Fielding Error=NULL

Football Craps—Overview and Rules

In a preferred embodiment of the present invention, as depicted, e.g., in FIG. 2, Football Craps is a game where each player will accrue points based on the recurrence of specific plays during a possession of a live football game.

Each possession will begin with the football shaped button in the OFF position

PASS LINE: While the button is in the OFF position, gameplay is initiated by placing chips on the Pass Line. In mobile applications, the Pass Line is illuminated upon selecting the chip. Chips values ($) correspond to a player's point score on a 1:1 basis.

When one of the specific Target Plays occurs in the football game (Big Pass, Big Run, 3rd Down Conversion, Big Loss, Offensive Penalty, Defensive Penalty), the button is moved to the ON position at the location of that play. The play designated by the button in the ON position is referred to as the Point. The Target Plays are defined as follows:

Big Pass: A pass reception where 15 yards or greater are gained by the offense;

Big Rush: A rush attempt where 8 yards or greater are gained by the offense;

3rd Down Conversion: The offense successfully makes sufficient yardage to gain a new set of downs on a 3^{rd}-down play;

Big Loss: The defense creates a tackle for loss of 4 yards or greater;

Defensive Penalty: The defense is charged with any penalty; and

Offensive Penalty: The offense is charged with any penalty.

If the Point play occurs again before the end of the team's possession, the Pass Line bet has won and the player will be awarded a proper payment amount.

Upon a winning Point, the button will revert back to the OFF position.

If the possession concludes without the Point recurring, the Pass Line chips are removed, the corresponding points are lost, and the button will revert back to the OFF position to start the next possession.

ODDS: while the button is in the ON position, a player may add to their Pass Line play an additional amount of chips up to 3× their initial play. This is done by placing chips directly behind the chips already placed on the Pass Line. In mobile applications, chips will be dragged to the Pass Line spot that is illuminated when the odds bet is available. The additional chips are called Odds, and upon winning, will be awarded additional points based on the likelihood of the Target Play recurring. In a particular embodiment, these odds may be listed with each Target Play's label on a game board. In preferred embodiments, odds may be updated to most accurately reflect actual gameplay results. In a particular embodiment, points may be awarded based on the following schedule:

Big Pass: Player is awarded 2 points for each 1 point played as Odds

Big Rush: Player is awarded 2 points for each 1 point played as Odds

Big Loss: Player is awarded 7 points for each 5 points played as Odds

3rd Down Conversion: Player awarded 7 points for each 5 points played as Odds

Offensive Penalty: Player is awarded 6 points for each 5 points played as Odds

Defensive Penalty: Player is awarded 6 points for each 5 points played as Odds

In a particular embodiment of Football Craps, there are the following INSIDE BETS: TOUCHDOWN—The TOUCHDOWN spot is active during the first series of downs for the offense as long as that possession begins outside the defense's 20-yard line. A set of downs is defined as a set of up to 4 downs used to attain a first down. The bet is made by placing chips on the TOUCHDOWN spot of the Game Board. In a preferred embodiment, the payout substantially corresponds to the real-time true odds calculated by the system prior to the point being set. In a particular embodiment, if an offensive touchdown is scored during the ensuing possession, the bet is won with a 4:1 payout.

FIELD GOAL—Similar to the TOUCHDOWN bet, the FIELD GOAL spot is active during the first series of downs for the offense, as long as that possession begins outside the defense's 40-yard line. The bet is made by placing chips on the FIELD GOAL spot of the Game Board. In a preferred embodiment, the payout substantially corresponds to the real-time true odds calculated by the system prior to the point being set. In a particular embodiment, if an offensive field goal is scored during the ensuing possession, the bet is won with a 4:1 payout.

ANY SCORE—This is a way of betting both the TOUCHDOWN spot and FIELD GOAL spot in a single bet. The ANY SCORE spot is active during the first series of downs for the offense, as long as that possession begins outside the defense's 40-yard line. The bet is made by placing chips on the ANY SCORE spot of the Game Board. In a preferred embodiment, the payout substantially corresponds to the real-time true odds calculated by the system prior to the point being set. In a particular embodiment, if either a touchdown or field goal is scored during the ensuing possession, the bet is won with a 2:1 payout.

TURNOVER—The TURNOVER spot is active during the first series of downs for the offense. The bet is made by placing chips on the TURNOVER spot of the Game Board. In a preferred embodiment, the payout substantially corresponds to the real-time true odds calculated by the system prior to the point being set. In a particular embodiment, if a fumble is recovered by the defense or an interception occurs to end that possession, the bet is won with a 6:1 payout. Please note: A turnover on downs is not considered a turnover for the sake of this bet.

SACK—The SACK spot is active at all times. The bet is made by placing chips on the SACK spot of the Game Board. In a particular embodiment, if the offensive quarterback is sacked in the following play, the bet is won with a 10:1 payout. Please note: the quarterback taking a knee, intentional grounding, and fumbles recovered by the quarterback are NOT considered sacks.

>20 YD GAIN—The >20 YD GAIN spot is active any time the offense has >20 yards left before the end zone. The bet is made by placing chips on the >20YD GAIN spot of the Game Board. In a particular embodiment, if the following offensive play results in a gain of more than 20 yards, the bet is won with a 10:1 payout. Please note: Yards gained due to a penalty are NOT considered yards gained for the sake of this bet.

BIG PLAY—The BIG PLAY spot is way of betting the SACK and >20YD GAIN spots in a single bet and adds single-play TURNOVER and TOUCHDOWN bets as well. It is active during a team's possession until they are within the 20-yard line. In a particular embodiment, if any of the following plays occurs during the following play, the bet is won with a 2:1 payout: Interception, Fumble Recovered By The Defense, Sack, >20yd Gain, Touchdown.

NO POINT—The NO POINT spot is active during the first series of downs for the offense. The bet is made by placing chips on the NO POINT spot of the Game Board. In a particular embodiment, if the offense completes its possession, without a Target Play occurring, the bet is won with a 1:2 payout meaning that for every 2 points that is wagered, 1 point is won. This bet is also called the “Oblio”.

POP UP BETS: from time to time, situation specific bets will be presented with their respective odds. These one-play bets, called Pop Up bets, will present themselves by the activation of the POP UP BETS spot, where players will be given the option to place or deny the wager. Examples of POP UP bets include:

Fourth Down Conversion: Active when a team is “going for it” on 4th down. In a particular embodiment, the bet is won with a successful conversion and features a payout of 2:1.

Kick Return for TD: Active before either a punt or kickoff, the bet is won is the kick is returned for a touchdown. In a particular embodiment, the payout is set at 50:1

Safety: Active when the offensive team has the ball inside their own 10 yard line, the bet is won if the defense scores a safety. In a particular embodiment, the payout is set at 20:1

Two Point Conversion: active when a team is attempting a 2-point conversion. The bet is won with a successful conversion. In a particular embodiment, the payout is set at 2:1.

PROP BETS: Prop Bets are player-to-player bets that have a multitude of possible permutations. Parameters such as teams/players involved, play outcome, odds, timeframe, bet amount, etc. are chosen by one player and proposed for acceptance by one or multiple other players. Once a prop bet has been accepted and completed based on the proposed timeline, odds and/or outcome, a separate game currency will be transferred to the winning player. Prop bets extend the game beyond the Game Board because wager wins/losses are transferred directly from player to player.

Football Craps—Comparison to Table Game Casino Craps

In the present invention, although Football Craps is very similar to the simpler aspects of conventional table game Casino Craps, the most salient difference is that the dice are replaced with plays of a live football game. In a typical Craps game, the button would start in the OFF position for a new roller and a point number would be established by their roll. The button would then be placed ON that number and the Pass Line bet would win if that number is rolled again before a “crap out seven”. In Football Craps, the button starts in the OFF position at the beginning of every possession (which is every time the teams switch offense vs. defense). Chips may be placed on the Pass Line any time the button is in the OFF position. The result of the plays in the live game MAY determine which of the 6 Target Plays that the button is moved ON to (Big Pass, Big Rush, 3rd Down Conversion, Offensive Penalty and Defensive Penalty) and the Pass Line bet will win if that type of play occurs before the end of the possession.

Come Line bets work just like in Casino Craps, as in they are the same as Pass Line bets, but occur after the button is already in the ON position.

Pass Line and Come Line odds work the same as in Casino Craps.

Inside Bets in Football Craps are similar to those on the Craps table game, such as the hard ways or the field. The bets are only available in certain situations, each have their odds, and each have their own defined interval determining when the bet is either won or lost. For detailed descriptions of each Inside Bet, please note the INSIDE BETS section above.

The Football Craps embodiments of present invention feature salient differences from conventional table game casino craps play, in part: (1) there are no placed bets in Football Craps, meaning that a player cannot bet specific outcomes of upcoming plays. The reason for this is that the odds for each play could change drastically depending on the specific teams and game situation, e.g., a game like this should not allow a player to bet “Offensive Penalty,” when, in fact, a team with a large lead toward the end of the game is burning off the clock and is obviously going to intentionally take a delay of game penalty; and (2) there are no automatic wins or losses when the button is OFF. Note, however, in particular embodiments, where the odds may be tracked and adjusted by the system in real-time to properly correspond and be properly calculated for the live sports event, place bets for specific game actions or outcomes may be set and offered, and such a system may provide for bets and bet resolution while the point is being established (i.e., when the button is in OFF position).

Note that in the present invention, there is no Don't Pass Bar. Note again, in particular embodiments, where the odds may be tracked and adjusted by the system in real-time to properly correspond and be properly calculated for the live sports event, the system may be configured to determine and set up the opportunity and option lay proper odds against a certain event occurring or recurring, and thus a don't pass bar-type bet may be implemented.

Note also, in particular embodiments, players may win twice in a single play. For example, there are a certain situations, such as 3rd Down Conversion via a 10 yard rush, where both a Come Line and Pass Line bet may win.

In a particular embodiment, the following rules apply: 1. Each player will start with 100 points; 2. Chips cannot be placed on specific plays; 3. Pass Line and Come Line chips cannot be removed once their Point has been established. These bets are now considered Active Bets; 4. Half points and partial points do not exist, and fractional points will always be rounded down. Therefore, whereas a 5 point bet on a point that yields 6:5 will pay 6 points, a 4 point bet on that same spot will only yield 4 points.

In a particular embodiment, the GOAL TO GO RULES apply, that is: 1. If a player has an active Pass Line or Come Line bet on Big Pass or Big Rush AND the live game presents a situation where not enough yards are left before the end zone to win the bet, a passing touchdown will win a Big Pass bet and a rushing touchdown will win a Big Rush bet; also, 2. If a player has both active Pass Line and Come Line bets on Big Pass and Big Rush AND a team in the live game attains a first down and goal, a situation will exist where the Pass Line and Come line bets can't both win. In this situation, the player will be given a choice as to which play will remain active for the remainder of the possession. The other bet will be removed, and the points returned to the player. Regardless of the Pass Line vs Come Line decision, the player may place a new Come Line bet for the next play.

In a particular embodiment, the following PLAY SPECIFIC RULES apply: 1. Offsetting Penalties: If there are offsetting penalties on the offense and defense, the play is considered NULL. The button will not be moved to either Offensive Foul or Defensive Foul, no Come Line bets will be moved, and no Pass Line or Come Line bets can be won. If, however, a major and minor penalty occur where the major penalty is enforced, this will be considered a foul against whichever team commits the major foul. 2. Dead Ball Fouls: Fouls that occur between plays WILL be counted as fouls in Football Craps. If, however, the dead ball foul occurs after a change of possession or score, whether enforced or not, it will be considered NULL.

Basketball Craps—Overview and Rules

In a preferred embodiment of the present invention, as depicted, e.g., in FIG. 3, Basketball Craps is a game where each player will accrue points based on the recurrence of specific plays during an interval of a live basketball game. In a particular preferred embodiment, an interval is defined as any time that expires between game stoppages on the referee's whistle. Each possession will begin with the basketball shaped button in the OFF position

PASS LINE: while the button is in the OFF position, gameplay is initiated by placing chips on the Pass Line. In mobile applications, the Pass Line is illuminated upon selecting the chip. Chips values ($) correspond to a player's point score on a 1:1 basis.

When one of the specific Target Plays occurs in the basketball game (3 Pointer, Jump Shot Made, Turnover, Slam Dunk, Offensive Rebound, Lead Change), the button is moved to the ON position at the location of that play. The play designated by the button in the ON position is referred to as the Point. The Target Plays are defined as follows:

3-Pointer: A player successfully makes a three-point shot from outside the arc;

Jump Shot Made: A player successfully makes a jump shot. Please note the definition of jump shot in the RULES section below;

Turnover: An offensive player gives the ball away or has it stolen;

Slam Dunk: A player successfully slam dunks the ball;

Offensive Rebound: An offensive player successfully rebounds the ball;

Lead Change: The score changes causing a lead change. Please note: For the sake of creating a new Target Play, a lead change will supersede any other Target Play. For example, if a 3-Point score causes a lead change while the button is OFF, this will place the button ON the Lead Change spot and not the 3-Pointer spot. When the button is in the ON position, the same play would win either the 3-Pointer or Lead Change Target Plays.

If the Point play occurs again before the end of the game interval, the Pass Line bet has won, and the bet is resolved. In a preferred embodiment, the player is awarded a payout that substantially corresponds to the proper odds for the target play. In another embodiment, the payout may equal the original bet. Upon a winning point, the button will revert back to the OFF position.

If the game interval concludes without the Point recurring, the player “sevens out,” the pass line chips are removed, the corresponding points are lost, and the button will revert back to the OFF position to start the next interval.

ODDS: while the button is in the ON position, a player may add to their Pass Line play an additional amount of chips up to 3× their initial play. This is done by placing chips directly behind the chips already placed on the Pass Line. In a mobile application, chips will be dragged to the Pass Line spot that is illuminated when the odds bet is available. The additional chips are called odds bets, and upon winning, will be awarded additional payouts or points based on the likelihood of the Target Play recurring. In a preferred embodiment, these odds are listed on each Target Play's label on the game board. In a most preferred embodiment, odds may be updated in substantially real-time to most accurately reflect true current gameplay odds. In a particular fixed odds embodiment, payouts or points are awarded based on the following schedule:

Offensive Rebound: Player is awarded 2 points for each 1 point played as Odds;

Turnover: Player is awarded 2 points for each 1 point played as Odds;

Slam Dunk: Player is awarded 7 points for each 5 points played as Odds;

Lead Change: Player awarded 7 points for each 5 points played as Odds;

3 Pointer: Player is awarded 6 points for each 5 points played as Odds; and

Jump Shot Made: Player is awarded 6 points for each 5 points played as Odds

COME LINE: while the button is in the ON position, a player may choose to place chips on the Come Line. Come Line play is similar to the Pass Line play, but can be done when the button is in the ON position. After the Come Line chips are placed, the next Target Play that occurs will be the Point for those chips. The chips will move to the corresponding location of that play, and if the play recurs before the possession ends, the Come Line has won.

As with the Pass Line, a player may add an additional amount of Odds chips up to 3× their initial Come Line play. This is done by placing additional chips next to the previously placed chips AFTER they have been moved to the Target Play or, in mobile applications, dragging chips to the area illuminated next to the Come bet chips after they have been moved. In a preferred embodiment, if the point for the come bet is made, the payout will substantially correspond to the true actual odds for the specific target play. In another embodiment, upon winning, the Odds chips will be awarded payout points based on the same schedule as fixed schedule Pass Line bets as detailed above.

In a preferred embodiment of the present invention, the games of Basketball Craps may feature INSIDE BETS, such as: ALLEY-OOP—The ALLEY-OOP spot is active at the initiation of each new game interval. The bet is made by placing chips on the ALLEY-OOP spot of the Game Board and will be activated by a Buffering Event. A Buffering Event is used to confirm that a bet is not placed in such a way as to beat the play-by-play stream. It is defined as an event of gameplay which must occur before a bet is officially accepted. After the buffering event, in a particular embodiment, each basket that is successfully scored on an alley-oop shot before the end of the game interval may win with a 10:1 odds payout.

BLOCK—The BLOCK spot is active at the initiation of each new game interval. The bet is made by placing chips on the BLOCK spot of the Game Board and is activated by a Buffering Event. In a particular embodiment, after the buffering event, each blocked shot that occurs before the end of the game interval may win with a 5:1 odds payout.

AND 1—The AND 1 spot is active at the initiation of each new game interval. The bet is made by placing chips on the AND 1 spot of the Game Board and is activated by a Buffering Event. In a particular embodiment, after the buffering event, if the next stoppage of play is due to a foul in the shooting where the shot scores, the bet may win with a 5:1 odds payout.

STEAL—The STEAL spot is active at the initiation of each new game interval. The bet is made by placing chips on the STEAL spot of the Game Board and is activated by a Buffering Event. In a particular embodiment, after the buffering event, each steal that occurs before the end of the game interval may win with a 3:1 odds payout.

JUMP BALL—The JUMP BALL spot is active at the initiation of each new game interval. The bet is made by placing chips on the JUMP BALL spot of the Game Board and is activated by a Buffering Event. In a particular embodiment, after the buffering event, if the next stoppage of play results in a jump ball, the bet may win with a 10:1 odds payout.

MAKE 1 MISS 1—The MAKE 1 MISS 1 spot is active when a player will be shooting 2 foul shots and must be made before the first shot is attempted. In a particular embodiment, if the player makes exactly one of the foul shots, the bet may win with a 2:1 odds payout.

OFFENSIVE REBOUND—The OFFENSIVE REBOUND spot is active at the initiation of each new game interval. The bet is made by placing chips on the OFFENSIVE REBOUND spot of the Game Board and is activated by a Buffering Event. In a particular embodiment, after the buffering event, each offensive rebound that occurs before the end of the game interval may win with a 3:1 odds payout.

POP UP BETS: from time to time, situation specific bets will be presented with their respective proper odds. These one-play bets, called Pop Up bets, will present themselves by the activation of the POP UP BETS spot, where players will be given the option to place or decline the wager. An example of a POP UP bets is: Final Minute Comeback: This bet will pop up with one minute left in the game when the score differential is 4 to 8 points. If the losing team comes back to win the game, the bet may win with a 10:1 odds payout.

PROP BETS: Prop Bets are player-to-player bets that have a multitude of possible permutations. Parameters such as teams/players involved, play outcome, odds, timeframe, bet amount, etc. are chosen by one player and proposed for acceptance by one or multiple other players. Once a prop bet has been accepted and completed based on the proposed timeline, odds and/or outcome, a separate game currency may be transferred to the winning player. Prop bets extend the game beyond the Game Board because wager wins/losses are transferred directly from player to player.

As depicted, e.g., in FIG. 3, a preferred embodiment features KEYED PLAYERS: This feature allows the user to choose a single athlete from one of the starting lineups at the beginning of the game. In a particular embodiment, if their select “keyed player” is the player that causes a bet to be won, the win payout may be doubled.

Basketball Craps—Comparison to Table Game Casino Craps

In the present invention, although Basketball Craps is very similar to the simpler aspects of table game Casino Craps, the most salient difference is that the dice are replaced with plays of a live basketball game. In a typical Craps game, the button would start in the OFF position for a new roller and a point number would be established by their roll. The button would then be placed ON that number and the Pass Line bet would win if that number is rolled again before a “crap out seven”. In Basketball Craps, the button starts in the OFF position at the beginning of every game interval (which is time that expires between game stoppages on the referee's whistle). Chips may be placed on the Pass Line any time the button is in the OFF position. The result of the plays in the live game MAY determine which of the 6 Target Plays that the button is moved ON to, including, e.g., offensive rebound, turnover, slam dunk, lead change, 3-point shot, and jump shot; and the Pass Line bet will win if that type of play occurs before the end of the interval.

Come Line bets work just like in Casino Craps, as in they are the same as Pass Line bets, but occur after the button is already in the ON position.

Pass Line and Come Line Odds Work the Same as in Casino Craps

Inside Bets in Basketball Craps are similar to those on the Craps table game, such as the hard ways or field bets. The bets are only available in certain situations, each have their odds and each have their own defined interval determining when the bet is either won or lost.

The Basketball Craps embodiments of present invention feature salient differences from conventional table game casino craps play, in part: (1) there are no placed bets in Basketball Craps, meaning that a player cannot bet specific outcomes of upcoming plays. The reason for this is that the odds for each play could change drastically depending on the specific teams and game situation, e.g., a game like this should not allow a player to bet on a “3-point shot,” when, in fact, the team with possession is down by 3 points with less than 24 seconds remaining in the game; and (2) there are no automatic wins or losses when the button is OFF. Note, however, in particular embodiments, where the odds may be tracked and adjusted by the system in real-time to properly correspond and be properly calculated for the live sports event, place bets for specific game actions or outcomes may be set and offered, and such a system may provide for bets and bet resolution while the point is being established (i.e., when the button is in OFF position).

Note that in the present invention, there is no Don't Pass Bar. Note again, in particular embodiments, where the odds may be tracked and adjusted by the system in real-time to properly correspond and be properly calculated for the live sports event, the system may be configured to determine and set up the opportunity and option lay proper odds against a certain event occurring or recurring, and thus a don't pass bar-type bet may be implemented.

Also, in the present invention system, the player can win twice in a single play. There are a couple of situations, such as lead change due to a made 3, where both a Come Line and Pass Line bet may win.

In a particular embodiment, the game may include the following rules: 1. Each player will start with 100 points; 2. Chips cannot be placed on specific plays; 3. Pass Line and Come Line chips cannot be removed once their Point has been established, as these bets are now considered Active Bets; 4. Half-points and partial points do not exist, and fractional points will always be rounded down. Therefore, whereas a 5 point bet on a point that yields 6:5 will pay 6 points, a 4 point bet on that same spot will only yield 4 points.

In particular embodiments, Basketball Craps will include adherence to the following rules:

BASKETBALL SHOTS: For the sake of this game, all shots will fall into one of 5 categories: Foul Shot, Jump Shot, 3 Point Shot, Slam Dunk and Layup

ALLEY-OOP: For the sake of this game an alley-oop is defined as play where a one player passes the ball near the basket to a teammate who catches the ball while in the air and immediately and successfully dunks it. The scoring of an alley-oop will be dependent on the official scoring of the game statistician.

Hockey Craps—Rules and Overview

In the present invention, as depicted, e.g., in FIG. 4, Hockey Craps is a game where each player will accrue points based on the recurrence of specific plays during an interval of a live hockey game. An interval is defined as any time that expires between game stoppages on the referee's whistle and subsequent faceoffs. Each possession is to begin with the puck shaped button in the OFF position

PASS LINE: while the button is in the OFF position, gameplay is initiated by placing chips on the Pass Line. In mobile applications, the Pass Line is illuminated upon selecting the chip. Chips values ($) correspond to a player's point score on a 1:1 basis.

In a preferred embodiment, when one of the specific Target Plays occurs in the hockey game (Home Team Shot on Goal, Visiting Team Shot on Goal, Home Team Missed Shot, Visiting Team Missed Shot, Puck Played By Goalie, Line Change), the button is moved to the ON position at the location of that play. The play designated by the button in the ON position is referred to as the Point. The Target Plays are defined as follows:

Shot on Goal (Home and Visiting Teams): The puck is shot or deflected towards the net and is either saved by the goalie or scores.

Missed Shot (Home and Visiting Teams): The puck is shot towards the net and is either wide or high of the net.

Puck Played By Goalie: The puck is possessed by the goalie and either frozen or played to another player

Line Change: A team changes at least 3 players on the ice

In a preferred embodiment, if the Point play occurs again before the end of the game interval, the Pass Line bet has won and the player will be awarded a payout that substantially reflects the true odds of the target event taking place. In another embodiment, the payout for a successful pass line outcome is an even money bet. Upon a winning Point, the button will revert back to the OFF position.

If the game interval concludes without the Point recurring, the Pass Line chips are removed, the corresponding points are lost, and the button will revert back to the OFF position to start the next interval.

ODDS: while the button is in the ON position, a player may add to their Pass Line play an additional amount of chips up to 3× their initial play. This is done by placing chips directly behind the chips already placed on the Pass Line. In a mobile application, chips will be dragged to the Pass Line spot that is illuminated when the odds bet is available. The additional chips are called Odds and upon winning, will be awarded additional points based on the likelihood of the Target Play recurring. In a particular embodiment, these odds are listed on each Target Play's label on the game board. In a preferred embodiment, odds may be updated in real-time to most accurately reflect true gameplay odds. In another particular embodiment, odds and payouts may be based on the following schedule:

Shot on Goal (Home and Visiting Teams): Player is awarded 2 points for each 1 point played as Odds;

Missed Shot (Home and Visiting Teams): Player is awarded 7 points for each 5 points played as Odds;

Line Change: Player awarded 6 points for each 5 points played as Odds; and

Puck Played By Goalie: Player is awarded 6 points for each 5 points played as Odds.

COME LINE: while the button is in the ON position, a player may choose to place chips on the Come Line. Come Line play is similar to the Pass Line play, but can be done when the button is in the ON position. After the Come Line chips are placed, the next Target Play that occurs will be the Point for those chips. The chips will move to the corresponding location of that play and if the play recurs before the possession ends, the Come Line has won.

In preferred embodiments, as with the Pass Line, a player may add an additional amount of Odds chips, e.g., up to 3X their initial bet as Come Line play. This is done by placing additional chips next to the previously placed chips AFTER they have been moved to the Target Play or, in mobile applications, dragging chips to the area illuminated next to the Come bet chips after they have been moved. Upon winning, the Odds chips will be awarded points based on the same applicable schedule as a successful Pass Line bet.

In a preferred embodiment, Hockey Craps features INSIDE BETS, such as: FIGHT—The FIGHT spot is active at the initiation of each new game interval. The bet is made by placing chips on the FIGHT spot of the Game Board and will be activated by a Buffering Event. A Buffering Event is used to confirm that a bet is not placed in such a way as to beat the play-by-play stream. It is defined as an event of gameplay which must occur before a bet is officially accepted. In a particular embodiment, after the buffering event, if the next stoppage of play is due to a fight on the ice, the bet will win and may pay out at 10:1 odds.

OFFSIDES—The OFFSIDES spot is active at the initiation of each new game interval. The bet is made by placing chips on the OFFSIDES spot of the Game Board and is activated by a Buffering Event. After the buffering event, if the next stoppage of play is due to an offsides call, the bet will win and may pay out at 3:1 odds.

PENALTY—The PENALTY spot is active at the initiation of each new game interval. The bet is made by placing chips on the PENALTY spot of the Game Board and is activated by a Buffering Event. After the buffering event, if the next stoppage of play is due to a penalty where a player or players must enter the penalty box, the bet will win and may pay out with 3:1 odds.

HIGH STICK—The HIGH STICK spot is active at the initiation of each new game interval. The bet is made by placing chips on the HIGH STICK spot of the Game Board and is activated by a Buffering Event. After the buffering event, if the next stoppage of play is due to a high stick call, the bet will win and may pay out with 8:1 odds.

ICING—The ICING spot is active at the initiation of each new game interval. The bet is made by placing chips on the ICING spot of the Game Board and is activated by a Buffering Event. After the buffering event, if the next stoppage of play is due to an icing call, the bet will win and may pay out with 4:1 odds.

SAVE—The SAVE spot is active at the initiation of each new game interval. The bet is made by placing chips on the SAVE spot of the Game Board and is activated by a Buffering Event. After the buffering event, each save that occurs before the end of the game interval will win and may pay out with 4:1 odds.

BAD FACEOFF—The BAD FACEOFF spot is active after each stoppage and must be made before the next faceoff. If that faceoff must be repeated, or if players are forced to change, a bad faceoff has occurred and the bet will win and may be set to pay out with 2:1 odds.

POP UP BETS: From time to time, situation-specific bets will be presented with their respective odds. These one-play bets, called Pop Up bets, will present themselves by the activation of the POP UP BETS spot, where players will be given the option to place or decline the wager. Examples of POP UP bets may include:

Penalty Shot Goal—This bet may pop up if a player is awarded a penalty shot. The bet must be placed before the penalty shot is taken and if the player scores, the bet may pay 3:2 odds.

Empty Net Goal—This bet may pop up when a team decided to pull their goalie at the end of a game. If the bet is taken and an empty net goal is scored, the bet may pay 1:1 odds (i.e., even money).

PROP BETS: Prop Bets are player-to-player bets that have a multitude of possible permutations. Parameters such as teams/players involved, play outcome, odds, timeframe, bet amount, etc. are chosen by one player and proposed for acceptance by one or more other players. Once a prop bet has been accepted and completed based on the proposed timeline, odds and/or outcome, a separate game currency will be transferred to the winning player. Prop bets extend the game beyond the Game Board because wager wins/losses are transferred directly from player to player.

KEYED PLAYERS: This feature allows the user to choose a single athlete from one of the starting lineups at the beginning of the game. In some embodiments, if the select “keyed player” is the player that causes a bet to be won, the win payout may be doubled.

Hockey Craps—Comparison to Table Game Casino Craps

In the present invention, although Hockey Craps is very similar to the simpler aspects of table game Casino Craps, the most salient difference is that the dice are replaced with plays of a live hockey game. In a typical Craps game, the button would start in the OFF position for a new roller and a point number would be established by their roll. The button would then be placed ON that number and the Pass Line bet would win if that number is rolled again before a “crap out seven”. In Hockey Craps, the button starts in the OFF position at the beginning of every interval (which is time that expires between faceoffs). Chips may be placed on the Pass Line any time the button is in the OFF position. The result of the plays in the live game MAY determine which of the 6 Target Plays that the button is moved ON to (Shot on Goal (H), Shot on Goal (V), Missed Shot (H), Missed Shot (V), Puck Played By Goalie, Line Change) and the Pass Line bet will win if that type of play occurs before the end of the game interval.

Come Line bets work just like in Casino Craps, as in they are the same as Pass Line bets, but occur after the button is already in the ON position.

Pass Line and Come Line Odds Work the Same as in Casino Craps.

Inside Bets in Hockey Craps are similar to those on the Craps table like the hard ways or field bets. The bets are only available in certain situations, each have their odds, and each have their own defined interval determining when the bet is either won or lost.

The Hockey Craps embodiments of present invention feature salient differences from conventional table game casino craps play, in part: (1) there are no placed bets in Hockey Craps, meaning that a player cannot bet on specific outcomes of upcoming play. The reason for this is that the odds for each target play of each time of play could change drastically depending on the specific teams and game situation, e.g., a game like this should not allow a player to bet “Line Change” when an obvious line change situation is upcoming, e.g., a penalty kill line has been on the ice for a minute and they are about to dump the puck; and (2) there are no automatic wins or losses when the button is OFF. Note, however, in particular embodiments, where the odds may be tracked and adjusted by the system in real-time to properly correspond and be properly calculated for the live sports event, place bets for specific target play game actions or outcomes may be set and offered, and such a system may provide for bets and bet resolution while the point is being established (i.e., when the button is in OFF position).

Note that in the present invention, there is no Don't Pass Bar. Note again, in particular embodiments, where the odds may be tracked and adjusted by the system in real-time to properly correspond and be properly calculated for the live sports event, the system may be configured to determine and set up the opportunity and option lay proper odds against a certain event occurring or recurring, and thus a don't pass bar-type bet may be implemented.

Note that in the present invention, the player may be able to win twice in a single play. There are a couple of situations, such as shot on net, gloved by the goalie, but then dished to his teammate, where both a Come Line and Pass Line bet may win.

In particular embodiments, the following Hockey Rules might apply: 1. Each player will start with 100 points; 2. Chips cannot be placed on specific plays; 3. Pass Line and Come Line chips cannot be removed once their Point has been established. These bets are now considered Active Bets; 4. Half points and partial points do not exist, and fractional points will always be rounded down. Therefore, for example, whereas a 5 point bet on a point that yields 6:5 will pay 6 points, a 4 point bet on that same spot will only yield 4 points.

In preferred embodiments, for an EMPTY NET situation: Pass Line, Come Line and Inside bets will be deactivated in the final seconds of a game if and when a team pulls their goalie.

Soccer Craps—Overview and Rules

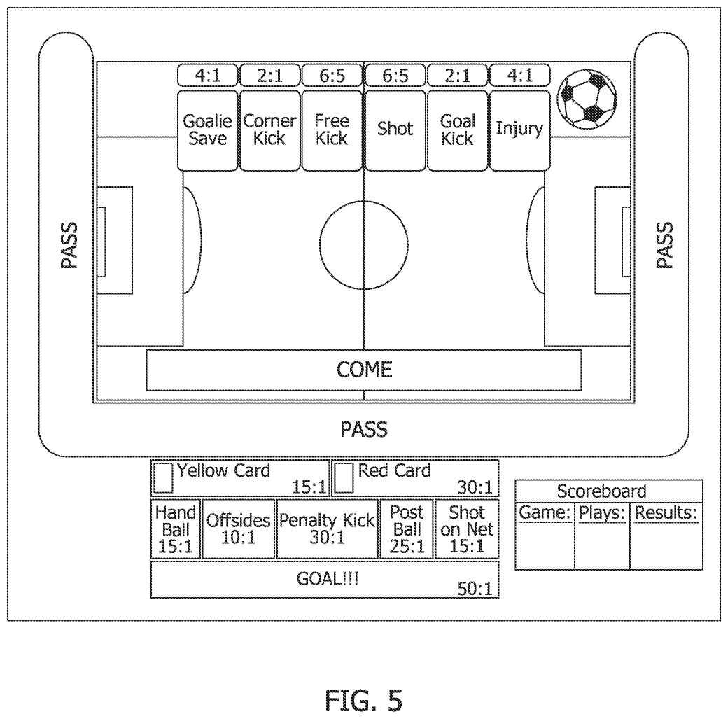

In the present invention, as depicted, e.g., in FIG. 5, Soccer Craps is a game where each player will accrue points based on the recurrence of specific plays during an interval of a live soccer game. An interval is defined as any time that expires between either the ball leaving the field over the sideline (live game interval between throw-ins), the end of a half, a penalty kick or a goal.

Each possession will begin with the soccer ball shaped button in the OFF position

PASS LINE: while the button is in the OFF position, gameplay is initiated by placing chips on the Pass Line. In mobile applications, the Pass Line is illuminated upon selecting the chip. Chips values ($) correspond to a player's point score on a 1:1 basis.

When one of the specific Target Plays occurs in the soccer game (Goalie Save, Free Kick, Injury, Shot, Goal Kick, Corner Kick), the button is moved to the ON position at the location of that play. The play designated by the button in the ON position is referred to as the Point. The Target Plays are defined as follows:

Goalie Save: Any time either goalie is awarded a save by the official statisticians;

Free Kick: Any kick awarded as the result of a foul;

Injury: Any time play is stopped due to a player injury, whether they leave the field or not;

Shot: Any shot taken by either team, whether on or off target;

Goal Kick: Either team is awarded a goal kick;

Corner Kick: Either team is awarded a corner kick;

If the Point play occurs again before the end of the game interval, the Pass Line bet has won and, in a preferred embodiment, the winning player will receive a payout that substantially corresponds to the actual odds of the target play occurring. In another embodiment, the player will be awarded an even money payout equal to the number of chips as was placed.

Upon a winning Point, the button will revert back to the OFF position.

If the game interval concludes without the Point recurring, the Pass Line chips are removed, the corresponding points are lost, and the button will revert back to the OFF position to start the next interval.

ODDS: While the button is in the ON position, a player may add to their Pass Line play an additional amount of chips up to 3× their initial play. This is done by placing chips directly behind the chips already placed on the Pass Line. In a mobile applications, chips will be dragged to the Pass Line spot that is illuminated when the odds bet is available. The additional chips are called Odds and upon winning, will be awarded additional points based on the likelihood of the Target Play recurring. In a particular embodiment, these odds are listed on each Target Play's label on the game board. In a preferred embodiment, Odds may be updated in real-time to most accurately reflect actual game play. In another embodiment, payouts or points may be awarded based on the following schedule:

Goalie Save: Player is awarded 4 points for each 1 point played as Odds;

Injury: Player is awarded 4 points for each 1 points played as Odds;

Corner Kick: Player is awarded 2 points for each 1 point played as Odds;

Goal Kick: Player awarded 2 points for each 1 points played as Odds;

Free Kick: Player is awarded 6 points for each 5 points played as Odds; and

Shot: Player is awarded 6 points for each 5 points played as Odds.

In a preferred embodiment, there are COME LINE bets: while the button is in the ON position, a player may choose to place chips on the Come Line. Come Line play is similar to the Pass Line play, but can be done when the button is in the ON position. After the Come Line chips are placed, the next Target Play that occurs will be the Point for those chips. The chips will move to the corresponding location of that play, and if the play recurs before the game play interval ends, the Come Line has won.

As with the Pass Line, a player may add an additional amount of Odds chips up to 3× their initial Come Line play. This is done by placing additional chips next to the previously placed chips AFTER they have been moved to the Target Play or, in mobile applications, dragging chips to the area illuminated next to the Come bet chips after they have been moved. Upon winning, the Odds chips will be awarded points based on the same schedule as the Pass Line.

INSIDE BETS: YELLOW CARD—The YELLOW CARD spot is active any time the ball is in play. The bet is made by placing chips on the YELLOW CARD spot of the Game Board and will be activated by a Buffering Event. A Buffering Event is used to confirm that a bet is not placed in such a way as to beat the play-by-play stream. It is defined as an event of gameplay which must occur before a bet is officially accepted. It may be a pass, shot, free kick or expiration of time and is reset by a “Play On” call by the referee. In a particular embodiment, after the buffering event, if the next stoppage of play results in a player being issued a yellow card, the bet is won with a 15:1 payout.

RED CARD—The RED CARD spot is active any time the ball is in play. The bet is made by placing chips on the RED CARD spot of the Game Board and will be activated by a buffering event. In a particular embodiment, after the buffering event, if the next stoppage of play results in a player being issued a red card, the bet is won with a 30:1 payout.

HAND BALL—The HAND BALL spot is active any time the ball is in play. The bet is made by placing chips on the HAND BALL spot of the Game Board and will be activated by a buffering event. In a particular embodiment, after the buffering event, if the next stoppage of play occurs due to a hand ball penalty being called, the bet is won with a 15:1 payout.

OFFSIDES—The OFFSIDES spot is active any time the ball is in play. The bet is made by placing chips on the OFFSIDES spot of the Game Board and will be activated by a buffering event (see definition above). In a particular embodiment, after the buffering event if the next stoppage of play occurs due to an offsides penalty being called, the bet is won with a 10:1 payout.

POST BALL—The POST BALL spot is active any time the ball is in play. The bet is made by placing chips on the POST BALL spot of the Game Board and will be activated by a buffering event. In a particular embodiment, after the buffering event, each time the ball hits the post before leaving the field over the sideline, the bet is won with a 25:1 payout.

SHOT ON NET—The SHOT ON NET spot is active any time the ball is in play. The bet is made by placing chips on the SHOT ON NET spot of the Game Board and will be activated by a buffering event. In a particular embodiment, after the buffering event, each time there is a shot on net before leaving the field over the sideline, the bet is won with a 15:1 payout.

PENALTY KICK—The PENALTY KICK spot is active any time the ball is in play. In a particular embodiment, the bet is made by placing chips on the PENALTY KICK spot of the Game Board. If the next stoppage of play occurs due to a hand ball penalty being called, the bet is won with a 15:1 payout.

GOAL—The GOAL spot is active any time the ball is in play. The bet is made by placing chips on the GOAL spot of the Game Board and will be activated by a buffering event. In a particular embodiment, after the buffering event, if a goal is scored before the ball leaves the field over the sideline, the bet is won with a 50:1 payout.

POP UP BETS: From time to time, situation specific bets will be presented with their respective odds. These one-play bets, called Pop Up bets, will present themselves by the activation of the PUP UP BETS spot, where players will be given the option to place or deny the wager. Examples of POP UP bets include:

Missed Penalty Shot: Active when a team is awarded a penalty shot. In a particular embodiment, the bet is won upon an unsuccessful attempt with a payout of 5:1.

Corner Kick Goal: Active when a team is awarded a corner kick. In a particular embodiment, the bet is won if the team scores within two touches of the corner kick with a payout of 5:1.

Free Kick Goal: Active when a team is awarded a free kick. In particular embodiment, the bet is won if the team scores directly off the kick with a payout of 10:1.

PROP BETS: Prop Bets are player-to-player bets that have a wide array of possible permutations. Parameters such as teams/players involved, play outcome, odds, timeframe, bet amount, etc. are chosen by one player and proposed for acceptance by one or more other players. Once a prop bet has been accepted and completed based on the proposed timeline, odds and/or outcome, a separate game currency will be transferred to the winning player. Prop bets extend the game beyond the Game Board because wager wins/losses are transferred directly from player to player.

KEYED PLAYERS: This feature allows the user to choose a single athlete from one of the starting lineups at the beginning of the game. In a particular embodiment, if their “keyed player” is the player that causes a bet to be won, the win payout is doubled.

Soccer Craps—Comparison to Table Game Casino craps

In the present invention, although Soccer Craps is very similar to the simpler aspects of table game Casino Craps, the most salient difference is that the dice are replaced with plays of a live soccer game. In a typical Craps game, the button would start in the OFF position for a new roller and a point number would be established by their roll. The button would then be placed ON that number and the Pass Line bet would win if that number is rolled again before a “crap out seven.” In Soccer Craps, the button starts in the OFF position at the beginning of every interval (which is the time between every throw in or kick off). Chips may be placed on the Pass Line any time the button is in the OFF position. The result of the plays in the live game MAY determine which of the 6 Target Plays that the button is moved ON to (Goalie Touch, Free Kick, 30 sec Possession, Shot, Goal Kick, Corner Kick) and the Pass Line bet will win if that type of play occurs before the end of the interval.

Come Line bets work just like in Casino Craps, as in they are the same as Pass Line bets, but occur after the button is already in the ON position.

Pass Line and Come Line odds work the same as in Casino Craps

Inside Bets in Soccer Craps are similar to those in the Craps table game, such as the hard ways or field bets. The bets are only available in certain situations, each have their odds and each have their own defined interval determining when the bet is either won or lost.

The Soccer Craps embodiments of present invention feature salient differences from conventional table game casino craps play, in part: (1) there are no placed bets in Soccer Craps, meaning that a player cannot bet on specific outcomes of upcoming play. The reason for this is that the odds for each segment of play could change drastically depending on the specific teams and game situation, e.g., a game like this should not allow a player to bet “Goal Kick” when, in fact, an obvious and likely goal kick situation is upcoming, e.g., one team is heavily pressuring the other team near or in the other's penalty area; and (2) there are no automatic wins or losses when the button is OFF. Note, however, in particular embodiments, where the odds may be tracked and adjusted by the system in real-time to properly correspond and be properly calculated for the live sports event, place bets for specific game actions or outcomes may be set and offered, and such a system may provide for bets and bet resolution while the point is being established (i.e., when the button is in OFF position).

Note that in the present invention, there is no Don't Pass Bar. Note again, in particular embodiments, where the odds may be tracked and adjusted by the system in real-time to properly correspond and be properly calculated for the live sports event, the system may be configured to determine and set up the opportunity and option lay proper odds against a certain target play event occurring or recurring, and thus a don't pass bar-type bet may be implemented.

In a particular embodiment of the Soccer Craps game, specific additional rules are as follows: 1. Each player will start with 100 points. 2. Chips cannot be placed on specific plays. 3. Pass Line and Come Line chips cannot be removed once their Point has been established. These bets are now considered Active Bets. 4. Half-points and partial points do not exist, and fractional points will always be rounded down. Therefore, whereas a 5 point bet on a point that yields 6:5 will pay 6 points, a 4 point bet on that same spot will only yield 4 points.

In preferred embodiments, the player may win twice in a single play. There are certain situations, such as a shot requiring a goalie save, where both a Come Line and Pass Line bet may win.

Tennis Craps—Overview and Rules

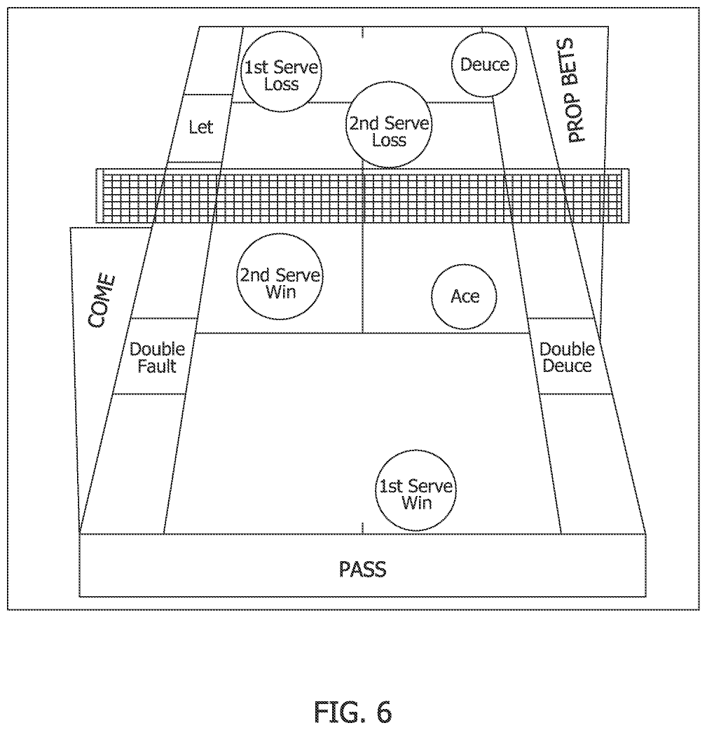

As depicted, e.g., in FIG. 6, Tennis Craps is a game where each player will accrue points based on the recurrence of specific outcomes during a game of a live tennis game. Each game will begin with the tennis ball-shaped button in the OFF position.

PASS LINE: While the button is in the OFF position, gameplay is initiated by placing chips on the Pass Line. In mobile applications, the Pass Line is illuminated upon selecting the chip. Chips values ($) correspond to a player's point score on a 1:1 basis.

When one of the specific Target Plays occurs in the tennis game (Point Won On First Serve, Point Lost On First Serve, Point Won on Second Serve, Point Lost On Second Serve, Ace, Deuce), the button is moved to the ON position at the location of that play. The play designated by the button in the ON position is referred to as the Point.

If the Point play occurs again before the end of that game, the Pass Line bet has won and, in a particular embodiment, the player will be awarded an equal number of chips as was placed.

Upon a winning Point, the button will revert back to the OFF position.

If the game concludes without the Point recurring, the Pass Line chips are removed, the corresponding points are lost, and the button will revert back to the OFF position to start the next game.

ODDS: While the button is in the ON position, a player may add to their Pass Line play an additional amount of chips up to 3× their initial play. This is done by placing chips directly behind the chips already placed on the Pass Line. In mobile applications, chips will be dragged to the Pass Line spot that is illuminated when the odds bet is available. The additional chips are called Odds and upon winning, will be awarded additional points based on the likelihood of the Target Play recurring. In a particular embodiment, these odds are listed on each Target Play's label on the game board. In a preferred embodiment, Odds may be updated in real-time to most accurately reflect true actual gameplay odds. In a particular embodiment, payouts or points may be awarded based on the following schedule:

First Serve Win: Player is awarded 6 points for each 5 points played as Odds;

Deuce: Player is awarded 6 points for each 5 points played as Odds;

First Serve Loss: Player is awarded 7 points for each 5 points played as Odds;

Second Serve Win: Player is awarded 7 points for each 5 points played as Odds;

Second Serve Loss: Player is awarded 2 points for each 1 point played as Odds; and

Ace: Player is awarded 2 points for each 1 point played as Odds.

COME LINE: while the button is in the ON position, a player may choose to place chips on the Come Line. Come Line play is similar to the Pass Line play but can be done when the button is in the ON position. After the Come Line chips are placed, the next Target Play that occurs will be the Point for those chips. The chips will move to the corresponding location of that play and if the play recurs before the game ends, the Come Line has won.

In a preferred embodiment, as with the Pass Line, a player may add an additional amount of Odds chips up to 3× their initial Come Line play. This is done by placing additional chips next to the previously placed chips AFTER they have been moved to the Target Play or, in mobile applications, dragging chips to the area illuminated next to the Come bet chips after they have been moved. Upon winning, the Odds chips will be awarded points based on the same schedule as the Pass Line.

INSIDE BETS: LET—The LET spot is active at the initiation of each new game. The bet is made by placing chips on the LET spot of the Game Board and will be activated by a Buffering Event. A Buffering Event is used to confirm that a bet is not placed in such a way as to beat the play-by-play stream. It is defined as an event of gameplay which must occur before a bet is officially accepted. In the case of the LET bet, in a particular embodiment, the Buffering Event is a recorded serve. In a particular embodiment, after the buffering event, each let that occurs before the end of the game will win with a payout of 4:1 odds.

DOUBLE FAULT—The DOUBLE FAULT spot is active at the initiation of each new game interval. The bet is made by placing chips on the DOUBLE FAULT spot of the Game Board and is activated by a Buffering Event. In the case of the DOUBLE FAULT bet, the Buffering Event is a recorded serve. In a particular embodiment, after the buffering event, any double fault that occurs before the end of the game interval will win with a payout of 8:1 odds.

DOUBLE DEUCE: The DOUBE DEUCE bet is active when a game begins and is available through a score of up to 30-15 or 15-30. The bet is that the game will see a deuce score twice or more before it ends. In a particular embodiment, a winning bet may award a payout of 6 points for every 5 that are bet.

POP UP BETS: From time to time, situation specific bets will be presented with their respective odds. These one-play bets, called Pop Up bets, will present themselves by the activation of the POP UP BETS spot, where players will be given the option to place or deny the wager.

PROP BETS: Prop Bets are player-to-player bets that have a multitude of possible permutations. Parameters such as teams/players involved, play outcome, odds, timeframe, bet amount, etc. are chosen by one player and proposed for acceptance by one or more other players. Once a prop bet has been accepted and completed based on the proposed timeline, odds and/or outcome, a separate game currency will be transferred to the winning player. Prop bets extend the game beyond the Game Board because wager wins/losses are transferred directly from player to player.

Tennis Craps—Comparison to Table Game Casino Craps

In the present invention, although Tennis Craps is very similar to the simplest aspects of table game Casino Craps, the most salient difference is that the dice are replaced with plays of a live tennis game. In a typical Craps game, the button would start in the OFF position for a new roller and a point number would be established by their roll. The button would then be placed ON that number and the Pass Line bet would win if that number is rolled again before a “crap out seven”. In Tennis Craps, the button starts in the OFF position at the beginning of every game of the match. Chips must be placed on the Pass Line before that player has completed their first serve. The result of that serve will determine which of the 6 Target Plays that the button is moved ON to (Point Won On First Serve, Point Lost On First Serve, Point Won on Second Serve, Point Lost On Second Serve, Ace, Deuce) and the Pass Line bet will win if that type of play occurs before the end of that game.

Come Line bets work just like in Casino Craps, as in they are the same as Pass Line bets, but occur after the button is already in the ON position.

Pass Line and Come Line Odds Work the Same as in Casino Craps

The Let, Double Fault and Deuce bets as similar to inside bets on the Craps table game, such as the hard ways or field bets.

The Tennis Craps embodiments of present invention feature salient differences from conventional table game casino craps play, in part: (1) there are no placed bets in Tennis Craps, meaning that a player cannot bet on specific outcomes of an upcoming game. The reason for this is that the odds for each target play of each game could change drastically depending on the specific players and game situation, e.g., a game like this should not allow a player to bet “point lost on second serve,” when, in fact, an obvious likely such situation is upcoming; and (2) there are no automatic wins or losses when the button is OFF. Note, however, in particular embodiments, where the odds may be tracked and adjusted by the system in real-time to properly correspond and be properly calculated for the live sports event, place bets for specific target plays or game actions or outcomes may be set and offered, and such a system may provide for bets and bet resolution while the point is being established (i.e., when the button is in OFF position).

Note that in the present invention, there is no Don't Pass Bar. Note again, in particular embodiments, where the odds may be tracked and adjusted by the system in real-time to properly correspond and be properly calculated for the live sports event, the system may be configured to determine and set up the opportunity and option lay proper odds against a certain target play event occurring or recurring, and thus a don't pass bar-type bet may be implemented.

In a particular embodiment of the Tennis Craps game, specific additional rules are as follows: 1. Each player will start with 100 points. 2. Chips cannot be placed on specific plays. 3. Pass Line and Come Line chips cannot be removed once their Point has been established. These bets are now considered Active Bets. 4. Half-points and partial points do not exist, and fractional points will always be rounded down. Therefore, whereas a 5 point bet on a point that yields 6:5 will pay 6 points, a 4 point bet on that same spot will only yield 4 points.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1. A system for managing wagering games corresponding to a live sporting event in real time, wherein a wagering game corresponding to a live sporting event in real time is presented to a user, further wherein the initiating wager event is contingent upon occurrence of a set play action in the live sporting event, wherein the set play action is subject to recurrence, further wherein the continuing live sporting event and contingent wagering game events and outcomes are presented, recorded, monitored, managed, resolved and communicated to the user.

2. The system of claim 1, wherein the wagering game is presented via a live casino-type gaming table.

3. The system of claim 1, wherein the wagering game further comprises pooled contests among users. the wagering game outcomes and payouts is presented simultaneously with an independent live craps game.

4. The system of claim 3, wherein the pooled contests among users further comprise the formation of user groups or leagues for peer-to peer game play.

5. The system of claim 1, wherein the wagering game rules, odds, outcomes and payouts are contingent upon the play actions of a live baseball game.

6. The system of claim 1, wherein the wagering game rules, odds, outcomes and payouts are contingent upon the play actions of a live football game.

7. The system of claim 1, wherein the wagering game rules, odds, outcomes and payouts are contingent upon the play actions of a live basketball game.

8. The system of claim 1, wherein the wagering game rules, odds, outcomes and payouts are contingent upon the play actions of a live hockey game.

9. The system of claim 1, wherein the wagering game rules, odds, and payouts are contingent upon the play actions of a live soccer match.

10. The system of claim 1, wherein the wagering game rules, odds, and payouts are contingent upon the play actions of a live tennis match.

11. A computer technology system for tracking, recording, interpreting, and communicating live play-by-play sporting event actions, wherein the computer technology system may track, adjust, and communicate the proper calculation of sporting event action odds in substantially real time without input of individual play-by-play sporting event actions by a user.

12. The computer technology system of claim 11, wherein the odds are communicated to a live wagering enterprise.

13. The computer technology system of claim 12, wherein the live wagering enterprise is a sportsbook.

14. The computer technology system of claim 13, wherein the live wagering enterprise is an online sportsbook.

15. The computer technology system of claim 12, wherein the live wagering enterprise is a live gaming table.

16. A computer technology system for tracking, recording, interpreting, and communicating live play-by-play sporting event actions, wherein the computer technology system may track, adjust, and communicate the proper calculation of sporting event actions odds in substantially real time, further wherein the computer technology system identifies and communicates sporting event action occurrences and proper odds payouts for wagers in substantially real time.

17. The computer technology system of claim 16, further wherein the computer technology system tracks, records, interprets, and communicates wagers based upon the occurrence of a select live sporting event action and contingent recurrence of a select sporting event action; and further wherein the computer technology system communicates proper odds payments and collection of wagers as result of sporting event actions in substantially real time.

18. The computer technology system of claim 17, wherein the system communicates the proper odds payments and collection of wagers to a live physical wagering location.

19. The computer technology system of claim 17, wherein the system communicates the proper odds payments and collection of wagers via online communications.

20. The computer technology system of claim 19, wherein the system communicates the proper odds payments and collection of wagers to a mobile computing device.
